(19) United States
(12) Patent Application Publication
(10) Pub. No.: US 2012/0110520 A1
(43) Pub. Date: May 3, 2012

(54) DEVICE FOR USING USER GESTURE TO REPLACE EXIT KEY AND ENTER KEY OF TERMINAL EQUIPMENT

(75) Inventor: Lili JIANG, Chaoyang (CN)

(73) Assignee: BEIJING BORQS SOFTWARE TECHNOLOGY CO., LTD., Chaoyang (CN)

(21) Appl. No.: 13/305,583

(22) Filed: Nov. 28, 2011

Related U.S. Application Data
(63) Continuation of application No. PCT/CN2010/077562, filed on Oct. 1, 2010.

(30) Foreign Application Priority Data
Mar. 31, 2010 (CN) 201020149168.6

(51) Int. Cl. G06F 3/033

(52) U.S. Cl. 715/863

(57) ABSTRACT

A device for using user gesture to replace the exit key and the enter key of a terminal equipment, comprising a CPU module, a gesture input module, a gesture processing module, a terminal application module, a memory module and a terminal function module. The CPU module can be connected with the gesture input module, the gesture processing module, the terminal application module, the memory module and the terminal function module, and can receive the user gesture input information sent by the gesture input module, the setting content information sent by the terminal application module, and the gesture identifying information sent by the gesture processing module. The CPU module can exit with or without saving from the received setting content information based on the gesture identifying information. The device increases the viewable area of the user and simplifies the human-machine interaction process.

### CROSS-REFERENCE TO RELATED APPLICATIONS

This application is a continuation of International Patent Application No. PCT/CN2010/077562, filed on Oct. 1, 2010, which claims foreign priority from CN 201020149168.6, filed on Mar. 31, 2010, the disclosures of each of which are incorporated herein by reference in their entirety.

### BACKGROUND

1. Field

The present disclosure generally relates to a mobile communication terminal, and in certain embodiments relates to cancel and okay buttons on a mobile communication terminal.

2. Description of the Related Art

Mobile communication terminals typically require users to confirm actions taken by the mobile communication terminals using “okay” or “cancel” buttons. Generally, the following are examples of design forms that require a user's confirmation:
1. A pop-up dialog box that comprises four parts: a title, content, an “okay” button, and a “cancel” button;
2. A symbol representing a “cancel” button at the upper right corner of the current window, such as the button used in the Windows Mobile operating system; and
3. A “cancel” button at the upper left corner and a “save” or “okay” button at the upper right corner of the current window, such as the buttons used in the iPhone.

In some cases, the existence of “cancel” and “okay” buttons limit the software and/or hardware design of a terminal. For example, these buttons may occupy a valuable visual area of the user. However, in many cases, owing to the intrinsic user demand of software that provides “user interaction”, a user presses an “okay” or a “cancel” button to decide the next step of operation. Therefore, it is typically not possible to remove the “okay” and “cancel” buttons as elements of the user interface design, thereby resulting in a contradiction between user demand and efficient interface design.

### SUMMARY

To solve or at least reduce the effects of some of the above-mentioned drawbacks, some embodiments of the present disclosure provide a device for replacing cancel and okay buttons of a terminal with user gestures. The device can utilize user gestures to replace the conventional “okay” and “cancel” buttons so as to remove a conventional confirmation dialog box and buttons that occupy a window area. Thus, this can increase the visual area for the user and simplify the human-machine interaction process.

In some embodiments, the present disclosure provides a device for replacing cancel and okay buttons of terminal equipment with user gestures. The device can comprise a central processing module, a gesture input module, a gesture processing module, a terminal application module, a memory module, and a terminal function module. As an example, the central processing module can be a central processing unit (CPU) module.

In some embodiments, the CPU module is connected (e.g., communicatively coupled) to the gesture input module, the gesture processing module, the terminal application module, the memory module, and/or the terminal function module. The CPU module can receive user gesture input information sent by the gesture input module, content setting information sent by the terminal application module, and gesture recognition information sent by the gesture processing module, and can process the received content change information according to the gesture recognition information.

In some embodiments, the gesture input module is connected (e.g., communicatively coupled) to the CPU module, the gesture processing module, and/or the terminal application module. In some embodiments, the gesture input module generates user gesture input information from received user gesture input and sends corresponding user gesture input information based, at least in part, on the received user gesture input, to the CPU module, the gesture processing module, and/or the terminal application module.

In some embodiments, the gesture processing module is connected (e.g., communicatively coupled) to the CPU module and/or the gesture input module and converts the received user gesture input information sent by the gesture input module into corresponding gesture recognition information. The gesture processing module can be configured to send the gesture recognition information to the CPU module.

In some embodiments, the terminal application module is connected (e.g., communicatively coupled) to the CPU module and/or the gesture input module and receives user gesture input information sent by the gesture input module. The terminal application module can change the content of the terminal application and can send content change information of the terminal application to the CPU module.

In some embodiments, the memory module (for example, gesture memory module) is connected (e.g., communicatively coupled) to the CPU module and receives save instruction information sent by the CPU module. The memory module can receive and save content change information of the terminal application.

For purposes of summarizing the disclosure, certain aspects, advantages and novel features of the inventions have been described herein. It is to be understood that not necessarily all such advantages can be achieved in accordance with any particular embodiment of the inventions disclosed herein. Thus, the inventions disclosed herein can be embodied or carried out in a manner that achieves or optimizes one advantage or group of advantages as taught herein without necessarily achieving other advantages as can be taught or suggested herein.

### BRIEF DESCRIPTION OF THE DRAWINGS

The accompanying drawings are provided to help further understanding of the present disclosure, and constitute a part of the specification. These drawings are used to describe certain embodiments of the present disclosure, but do not constitute any limitation to the present disclosure. In the drawings:

FIG. 1 is a schematic block diagram of the device for replacing cancel and okay buttons of the terminal equipment with user gestures.

FIG. 2 is a working schematic diagram of the device for replacing cancel and okay buttons of the terminal equipment with user gestures.

### DETAILED DESCRIPTION

Hereunder, various embodiments will be described with reference to the accompanying drawings. It should be appreciated that the embodiments described herein are only provided to describe and interpret the disclosure, but do not constitute any limitation to the disclosure.

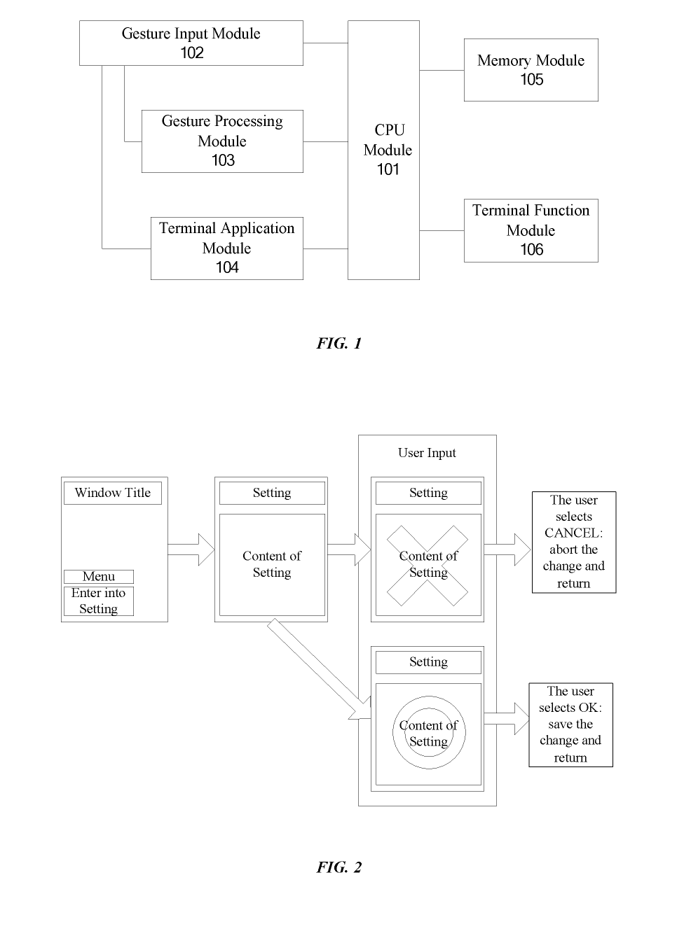

FIG. 1 is a schematic block diagram of the device for replacing cancel and okay buttons of the terminal equipment with user gestures. As shown in FIG. 1, the device for replacing cancel and okay buttons with user gestures of the terminal equipment can comprise a CPU module 101, a gesture input module 102, a gesture processing module 103, a terminal application module 104, a memory module 105, and a terminal function module 106.

In some embodiments, CPU module 101 is connected (e.g., communicatively coupled) to gesture input module 102, gesture processing module 103, terminal application module 104, memory module 105, and/or terminal function module 106. CPU module 101 can receive user gesture input information sent by the gesture input module 102 and can receive and control gesture processing module 103 and terminal application module 104. In further embodiments, CPU module 101 can receive content setting information sent by terminal application module 104 and gesture recognition information sent by gesture processing module 103 and can process received content change information according to gesture recognition information. CPU module 101 can send confirmed content change information to memory module 105 to exit settings of the application with or without saving. In some embodiments, CPU module 101 controls operation of terminal function module 106.

In some embodiments, gesture input module 102 employs or comprises a touch type input module (for example, a touch pad or touch screen), which can be connected (e.g., communicatively coupled) to CPU module 101, gesture processing module 103, and/or terminal application module 104. Gesture input module 102 can receive user gesture input (for example, the sliding of a user's finger(s) on the gesture input module 102) and can generate user gesture input information from the user gesture input. In some embodiments, gesture input module 102 sends the generated user gesture input information to CPU module 101, gesture processing module 103, and/or terminal application module 104.

In certain aspects, a touch input module can be bonded (for example, communicatively or physically coupled) to a display screen and a user can draw symbols on the display screen. In some embodiments, the terminal operating system may support “full-screen touch.” In other aspects, a touch input module can be bonded to another unit of the terminal (for example, a keyboard or a casing of the terminal) and the user may only need to draw symbols within an input area of the corresponding unit.

In some embodiments, gesture processing module 103 is connected (e.g., communicatively coupled) to CPU module 101 and/or gesture input module 102 and receives user gesture input information sent by gesture input module 102. Gesture processing module 103 can convert user gesture input information into corresponding gesture recognition information and can send the gesture recognition information to CPU module 101. In some embodiments, gesture recognition information includes okay gesture information (for example, which can be a sliding path “∘” drawn by a user's fingers on a screen or other gesture input module of the terminal, or which can be any other user-defined sliding path symbol, gesture, or action defined and drawn by the user on the screen or other gesture input module of the terminal) and cancel gesture information (for example, which can be a sliding path “x” drawn by a user's fingers on a screen or other gesture input module of the terminal, or which can be any other sliding path symbol, gesture or action defined and drawn by the user on the screen or other gesture input module of the terminal). In an embodiment, a symbol “∘” is used to indicate okay gesture information and a symbol “x” is used to indicate cancel gesture information.

In some embodiments, terminal application module 104 is connected (e.g., communicatively coupled) to CPU module 101 and/or gesture input module 102 and receives user gesture input information sent by gesture input module 102. In some embodiments, terminal application module 104 changes content of the terminal application and sends content change information of terminal application to CPU module 101.

In some embodiments, gesture memory module 105 is connected (e.g., communicatively coupled) to CPU module 101 and can receive save instruction information sent by CPU module 101. In some embodiments, gesture memory module 105 receives and saves content change information of a terminal application.

In some embodiments, terminal function module 106 is connected (e.g., communicatively coupled) to CPU module 101 and can receive instruction information sent by CPU module 101. In some embodiments, terminal function module 106 executes functional actions of a mobile communication terminal based, at least in part, on the instruction information.

FIG. 2 is a working schematic diagram of a device for replacing cancel and okay buttons of the terminal equipment with user gestures. As shown in FIG. 2, after a terminal enters into an application setting, terminal application module 104 can utilize gesture input module 102 to change detailed content of a terminal application. In an embodiment, gesture processing module 103 waits for gesture input module 102 to send required user gesture input information. Gesture processing module 103 can receive expected user gesture input information sent by gesture input module 102 and can convert user gesture input information into gesture recognition information. In some embodiments, gesture processing module 103 sends gesture recognition information to CPU module 101.

In some embodiments, CPU module 101 receives gesture recognition information sent by gesture processing module 103. CPU module 101 can identify gesture recognition information. In an embodiment, if gesture recognition information is represented by the symbol “∘” (okay gesture information), CPU module 101 sends save instruction information and content setting information of terminal application to gesture memory module 105 to save content change information of terminal application and exit the terminal application setting. In an embodiment, if gesture recognition information is represented by the symbol “x” (cancel gesture information), CPU module 101 cancels a change of terminal application content and exits the terminal application setting.

In an embodiment, the device for replacing cancel and okay buttons of the terminal equipment with user gestures employs gesture information “∘” and “x” to indicate “okay” and “cancel,” respectively. In some embodiments, the device replaces “okay” and “cancel” buttons on conventional terminals so as to remove conventional confirmation dialog boxes and/or buttons that may occupy a window area. Thus, a visual and usable area for the user may be increased and user input operations may be simplified. A user can draw “∘” and “x” symbols on a touch input module to confirm his or her decision.

Many other variations than those described herein will be apparent from this disclosure. For example, depending on the embodiment, certain acts, events, or functions of any of the algorithms described herein can be performed in a different sequence, can be added, merged, or left out all together (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

What is claimed is:

1. A device for replacing “cancel” and “okay” input buttons of a mobile communication terminal with user gesture inputs, comprising:
a central processing unit module communicatively coupled to a gesture input module, a gesture processing module, a terminal application module, a gesture memory module, and a terminal function module;
wherein the gesture input module is further communicatively coupled to the gesture processing module and the terminal application module and is configured to generate user gesture input information based on a user gesture input received from a user and send the user gesture input information to the central processing unit module, the gesture processing module, and the terminal application module;
wherein the gesture processing module is further communicatively coupled to the gesture input module and is configured to convert the user gesture input information received from the gesture input module into gesture recognition information and send the gesture recognition information to the central processing unit module;
wherein the terminal application module is configured to change content of a terminal application, generate content change information based on the user gesture input information received from the gesture input module, and send the content change information to the central processing unit module;
wherein the central processing unit module is configured to process the user gesture input information, the content change information, and the gesture recognition information to generate a save instruction and a functional instruction;
wherein the gesture memory module is configured to receive and save the content change information from the central processing unit module based at least in part on the save instruction received from the central processing unit module; and
wherein the terminal function module is configured to receive the functional instruction from the central processing unit module and execute functional actions of a mobile communication terminal based at least in part on the functional instruction.

2. The device of claim 1, wherein when the gesture recognition information comprises okay gesture information, the central processing unit module is configured to send the content change information to the gesture memory module for storage and to exit a terminal application setting.

3. The device of claim 2, wherein the okay gesture information is generated based on a sliding-path “O” symbol drawn by a user on a screen communicatively coupled to the gesture input module of the device.

4. The device of claim 1, wherein when the gesture recognition information received comprises cancel gesture information, the central processing unit module is configured to directly exit a terminal application setting.

5. The device of claim 4, wherein the cancel gesture information is generated based on a sliding-path “X” symbol drawn by a user on a screen communicatively coupled to the gesture input module of the device.

6. The device of claim 1, wherein the gesture input module is a touch input module.
